(19) United States
(12) Patent Application Publication
(10) Pub. No.: US 2013/0265420 A1
(43) Pub. Date: Oct. 10, 2013

(54) VIDEO PROCESSING APPARATUS, VIDEO PROCESSING METHOD, AND RECORDING MEDIUM

(71) Applicant: CANON KABUSHIKI KAISHA, Tokyo (JP)

(72) Inventor: Keiji Adachi, Kawasaki-shi (JP)

(73) Assignee: CANON KABUSHIKI KAISHA, Tokyo (JP)

(21) Appl. No.: 13/792,955

(22) Filed: Mar. 11, 2013

(30) Foreign Application Priority Data
Apr. 4, 2012 (JP) 2012-085892

(51) Int. Cl. G06K 9/00

(52) U.S. Cl. CPC G06K 9/00771
USPC 348/143

(57) ABSTRACT

A video processing apparatus comprising: a setting unit that sets one of a line and a graphic pattern on a display screen of a video; and a detection unit that detects, in accordance with an angle of one of the line and the graphic pattern set by the setting unit, a specific object from video data to display the video on the display screen.

### BACKGROUND OF THE INVENTION

1. Field of the Invention

The present invention relates to a video processing apparatus, a video processing method, and a recording medium.

2. Description of the Related Art

Conventionally, when sensing the passage of an object such as a human body through a specific point in a video using a video obtained from a monitoring camera or the like, the object detected from the video is tracked in the screen, and the passage through the specific point is detected.

In Japanese Patent Laid-Open No. 2002-373332, an object is detected based on a motion vector, a search position in the next frame is estimated, and the object is tracked by template matching.

In Japanese Patent Laid-Open No. 2010-50934, face detection is performed, and face tracking is performed using motion information detected from the correlation between the current frame and a past frame. A passage of an object through a specific point can be determined based on the tracking result.

In general, to detect an object such as a human body or a face by video analysis processing, one or, in accordance with the angle, a plurality of collation patterns (dictionaries) storing object features are used, thereby detecting an object matching the collation pattern from an image. In passage sensing by video analysis processing, the passage of an object is determined by detecting crossing of a track line representing the tracking locus of the object across a determination line segment or determination region frame set in the screen.

In Japanese Patent Laid-Open No. 2007-233919, a moving object in a camera image is detected as a moving mass. In addition, an intrusion prohibiting line is set in the camera image, thereby sensing an intruder.

The processing of detecting the object to be used for passage sensing is required to be executed at a high speed based on background such as an increase in the number of pixels of a network camera device or the necessity of accurate real-time processing in monitoring or the like.

However, the processing load of object detection processing in the template matching or the like is heavy. For this reason, the processing is performed by time-serially thinning the processing image frames so as to lower the detection processing frequency to a processable level. Alternatively, not the real-time processing but batch processing is performed for a recorded video.

Since an object moves in every direction in a video of a monitoring camera, the object can take any orientations. For this reason, the processing load becomes heavier when accurate template matching is performed using collation patterns (dictionaries) of a plurality of orientations such as a front orientation and a lateral orientation. Accurate detection processing needs to be performed slowly under heavy load. High-speed detection processing needs to be performed under light load. That is, there exists a tradeoff relationship.

### SUMMARY OF THE INVENTION

According to the present invention, there is provided a video processing apparatus comprising: a setting unit that sets one of a line and a graphic pattern on a display screen of a video; and a detection unit that detects, in accordance with an angle of one of the line and the graphic pattern set by the setting unit, a specific object from video data to display the video on the display screen.

According to the present invention, there is provided a video processing method comprising: a setting step of setting one of a line and a graphic pattern on a display screen of a video; and a detection step of detecting, in accordance with an angle of one of the line and the graphic pattern set in the setting step, a specific object from video data to display the video on the display screen.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an image processing apparatus 100;

FIG. 2 is a view showing an example of the arrangement of a parameter;

FIGS. 3A and 3B are views showing an example of association between an object and a human body;

FIG. 4 is a view showing an example of the arrangement of information managed by a locus management unit 107;

FIG. 5 is a view for explaining passage determination of a human attribute object;

FIG. 6 is a view showing an example of the set direction angle of a sensing line for sensing;

FIG. 7 is a flowchart showing the processing procedure of the image processing apparatus 100;

FIG. 8 is a flowchart showing the procedure of subroutine processing of human body detection processing;

FIG. 9 is a view showing an example of a collation pattern table used in human body detection processing; and

FIG. 10 is a view showing an example of a screen to perform human body detection processing.

### DESCRIPTION OF THE EMBODIMENTS

### First Embodiment

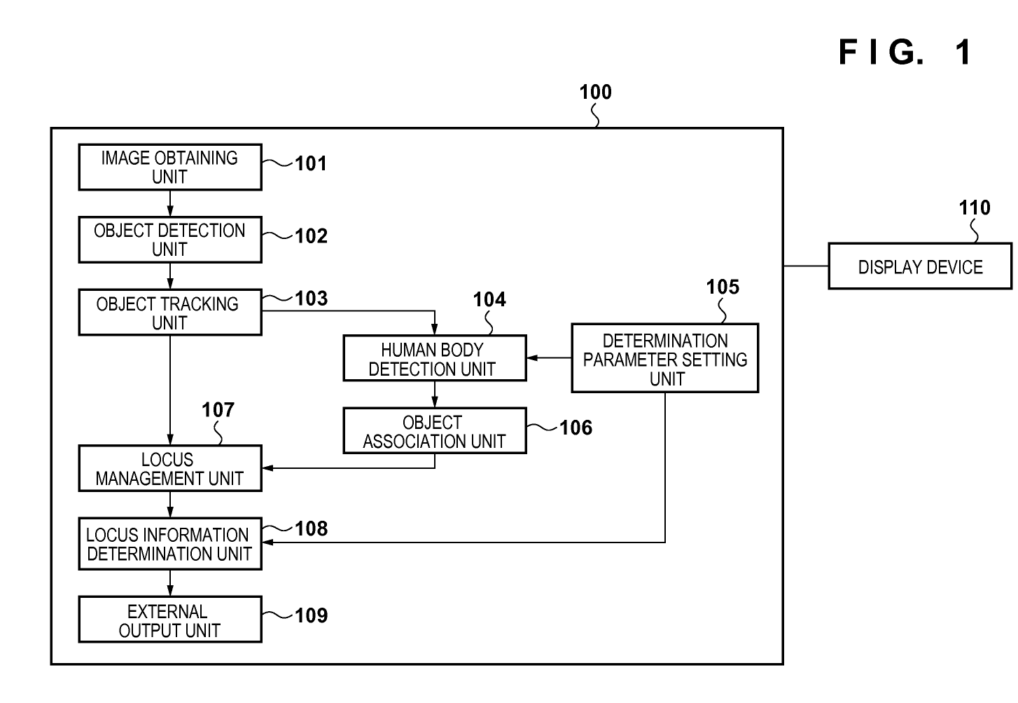

An example of the arrangement of an image processing apparatus (video processing apparatus) 100 according to the first embodiment will be described with reference to FIG. 1. The image processing apparatus 100 can be a general PC (Personal Computer), an image processing circuit mounted in a camera capable of capturing a moving image, or any other device. The image processing apparatus 100 has a function of displaying a moving image including a moving object on a display screen, thereby detecting that the object moving in the display screen has passed a sensing line for object passage sensing set in the display screen.

The image processing apparatus 100 includes an image obtaining unit 101, an object detection unit 102, an object tracking unit 103, a human body detection unit 104, a determination parameter setting unit 105, an object association unit 106, a locus management unit 107, a locus information determination unit 108, and an external output unit 109. The image processing apparatus 100 is connected to a display device 110 formed from a CRT (Cathode Ray Tube) or a liquid crystal panel. The display device 110 displays a processing result of the image processing apparatus 100 by an image or text. A case will be described below in which a moving image is displayed on the display screen of the display device 110.

The image obtaining unit 101 obtains an externally supplied moving image or still image and sends the obtained moving image or still image to the object detection unit 102. Upon obtaining a moving image, the image obtaining unit 101 sequentially sends the frames of the moving image to the object detection unit 102. Upon obtaining a still image, the image obtaining unit 101 sends the still image to the object detection unit 102. Note that the supply source of the moving image or the still image is not particularly limited. The supply source can be a server apparatus or image capture apparatus that supplies a moving image or a still image via a cable or wirelessly. The supply source is not limited to an external apparatus, and a moving image or a still image may be obtained from the internal memory (not shown) of the image processing apparatus 100. A case will be explained below in which one image is sent to the object detection unit 102 regardless of whether the image obtaining unit 101 has obtained a moving image or a still image. In the former case, the one image corresponds to each frame of the moving image. In the latter case, the one image corresponds to the still image.

The object detection unit 102 detects an object from the frame image obtained from the image obtaining unit 101 by the background subtraction method. The information of the detected object includes a position on the screen, a circumscribed rectangle, and the object size. The object detection unit 102 has a function of detecting an object from an image, and the method is not limited to a specific one.

If the object detection unit 102 has detected, from the image of a frame of interest, the same object as that detected from a frame immediately before the frame of interest, the object tracking unit 103 associates the objects in the respective frames with each other. For example, assume that the object tracking unit 103 assigns an object ID =A to the object detected by the object detection unit 102 from the image of the frame immediately before the frame of interest. If the object detection unit 102 has detected this object from the image of the frame of interest, too, the object tracking unit 103 assigns the object ID=A to this object as well. If identical objects are detected throughout a plurality of frames, the same object ID is assigned to the objects. Note that an object newly detected in the frame of interest is assigned a new object ID.

The human body detection unit 104 stores collation patterns used to detect a specific object from video data. The human body detection unit 104 decides a collation pattern dictionary to be used, based on the arrangement direction (angle) information of a sensing line set by the determination parameter setting unit 105 to be described later. The human body detection unit 104 then performs human body detection processing for the region detected by the object detection unit 102, thereby detecting a human body. Note that details of the collation pattern decision method will be described later. The human body detection unit 104 need only have a function of detecting a human body from an image. However, the method is not limited to pattern processing. In this embodiment, the detection target is a human body. However, the detection target is not limited to a human body, and may be a human face, a vehicle, an animal, or the like. A specific object detection unit for detecting a plurality of types of specific objects may be provided. If a plurality of detection processes can be performed simultaneously, a plurality of specific object detection processes may be executed. It is not always necessary to perform human body detection in the region detected by the object detection unit 102. The human body detection processing may be performed for the entire image.

The determination parameter setting unit 105 obtains or sets a determination parameter used to determine whether the object in the image of each frame has passed a sensing line for object sensing, that is, setting information that defines the sensing line for object sensing. The determination parameter setting unit 105 sends the obtained or set determination parameter to the human body detection unit 104 or the locus information determination unit 108 to be described later.

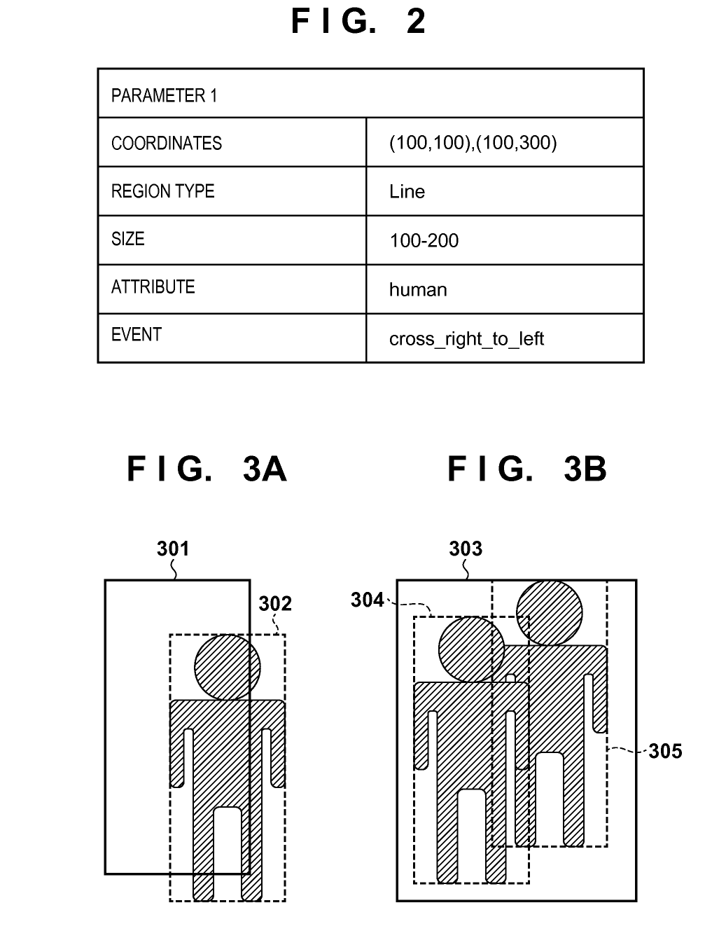

An example of the arrangement of the determination parameter obtained or set by the determination parameter setting unit 105 will be described with reference to FIG. 2. The determination parameter shown in FIG. 2 defines, as the sensing line for object sensing, a line that connects coordinates (100, 100) and coordinates (100, 300) on a coordinate system defined on the display screen of the display device 110. The determination parameter also defines that when a human attribute object having a size of 100 to 200 has passed the sensing line from right to left (cross_right_to_left), the object should be set as the sensing target. Note that the passage direction from the start point to the end point for passage determination can be set to one of a direction from left to right (cross_left_to_right) (first passage direction), a direction from right to left (cross_right_to_left) (second passage direction), and both-way (cross_both).

The determination parameter setting unit 105 can set, as the sensing line for object sensing, a polygonal sensing line having a plurality of nodes or a plurality of sensing lines at different positions. The determination parameter setting unit 105 may set a graphic pattern such as a rectangle in place of the sensing line for object sensing.

In the above-described way, the determination parameter setting unit 105 sets a line or a graphic pattern on the display screen of the video. In the above-described way, the determination parameter setting unit 105 sets the passage direction in which an object passes the set line or graphic pattern.

The collation pattern decision method and human body detection processing by the human body detection unit 104 when the determination parameter obtained or set by the determination parameter setting unit 105 has been output to the human body detection unit 104 will be described below.

When detecting a human body, the processing speed or detection accuracy can be expected to be improved by selectively using the collation pattern in a front orientation or a lateral orientation. However, the collation pattern is not limited to the front orientation or the lateral orientation. The collation pattern may have another angle such as an oblique or upward orientation. The collation pattern is not limited to the whole human body and may be specialized to the upper half, face, or feet of a human body. The collation pattern is not limited to only the human body and may be created to detect a specific target such as a face, a vehicle, a train, or an airplane. For a specific object other than a human body, including an object asymmetrical in the leftward/rightward direction and an object asymmetrical in the forward/backward direction as well, a plurality of collation patterns are usable in accordance with the capture angle of the specific object, for example, the vertical direction or horizontal direction.

In this embodiment, the human body detection unit 104 decides the collation pattern in accordance with the orientation of the sensing line for sensing obtained from the determination parameter setting unit 105. In the example shown in FIG. 2, the orientation of the sensing line for sensing indicated by the coordinates of the determination parameter on the screen is the vertical direction downward from above. For this reason, the collation pattern is decided to a laterally-oriented human body collation pattern to accurately detect a human body that moves in the horizontal direction perpendicular to the sensing line and passes the sensing line. On the other hand, if a determination parameter representing a sensing line arranged not in the vertical direction but in the horizontal direction is input, the collation pattern is decided to a front-oriented collation pattern.

An example of the set direction angle of the sensing line will be described with reference to FIG. 6. A sensing line 601 for detection is a line set on the screen or a line segment that connects a start point 602 of the sensing line and an end point 603 of the sensing line. If the passage direction information set for the sensing line 601 is “cross_left_to_right”, the direction to determine the passage of an object across the sensing line 601 in the screen is a passage direction 604. In the image, the rightward direction is defined as the positive direction of the x axis, and the downward direction as the positive direction of the y axis. A set angle 605 (angle α) of the sensing line 601 is defined counterclockwise in FIG. 6 while defining the positive direction of the y axis as 0°. The collation pattern to be used in human body detection processing is decided in accordance with the set angle 605 (angle α) of the sensing line 601.

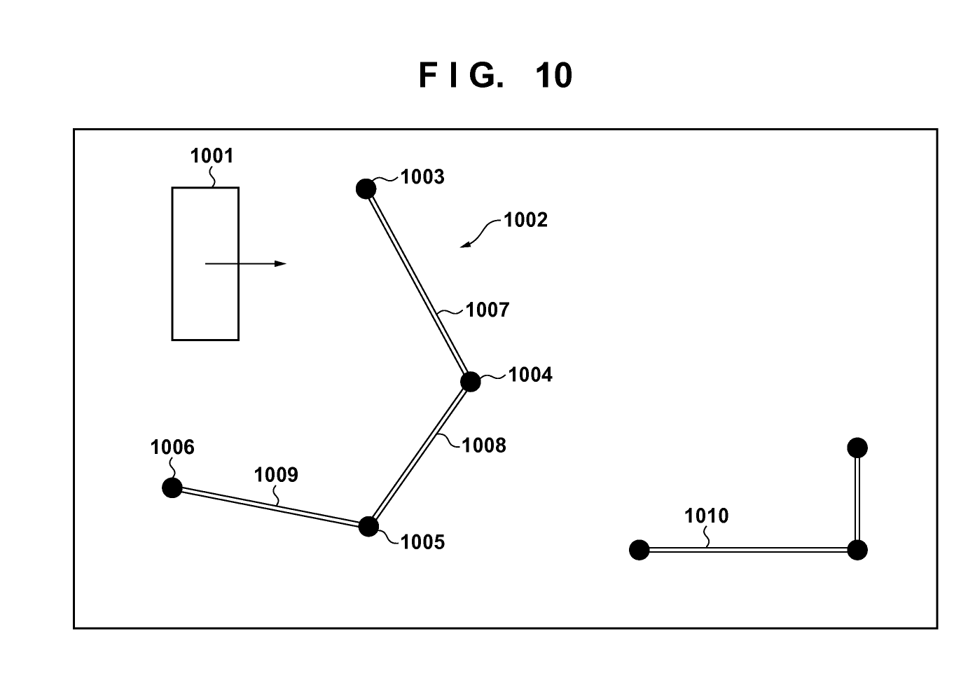

FIG. 9 shows an example of a table that stores collation patterns used in human body detection processing. The patterns shown in FIG. 9 represent examples of a plurality of types of collation patterns stored by the human body detection unit 104. Referring to FIG. 9, the detection corresponding angles of the collation pattern of ID “1” are 45°≦α<135° and 225°≦α<315°. This indicates that the detection accuracy is high, the detection target is a human body, and the collation pattern corresponds to laterally-oriented human body detection. The detection corresponding angles of the collation pattern of ID “2” are 0°≦α<45°, 135°≦α<225°, and 315°≦α<360°. This indicates that the detection accuracy is high, the detection target is a human body, and the collation pattern corresponds to front-oriented human body detection. The detection corresponding angle of the collation pattern of ID “3” is 0°≦α<360°. This indicates that the detection accuracy is low, the detection target is a human body, and the collation pattern can detect a human body captured from any direction only at a low detection accuracy.

Processing of causing the human body detection unit 104 to decide the collation pattern using the collation pattern table shown in FIG. 9 based on the sensing line set angle α of the sensing line 601 will be described here. When the sensing line set angle α is 0° (inclusive) to 45° (exclusive), 135° (inclusive) to 225° (exclusive), or 315° (inclusive) to 360° (exclusive), the collation pattern is decided to the collation pattern dictionary (front-oriented human body dictionary) of ID “2”. On the other hand, when the sensing line set angle α is 45° (inclusive) to 135° (exclusive) or 225° (inclusive) to 315° (exclusive), the collation pattern is decided to the collation pattern dictionary (laterally-oriented human body dictionary) of ID “1”.

In this embodiment, the arrangement for switching the collation pattern in accordance with the value of the sensing line set angle α has been described. If the sensing line set angle α is included in a predetermined range, the decision may be done to use both the collation patterns. More specifically, when the sensing line is arranged obliquely, the human body that passes the sensing line can be either front-oriented or laterally-oriented. Hence, the decision may be made to use both the collation patterns. For example, when the sensing line set angle α is 30° (inclusive) to 60° (exclusive), 120° (inclusive) to 150° (exclusive), 210° (inclusive) to 240° (exclusive), or 300° (inclusive) to 335° (exclusive), the decision may be done to use both the laterally-oriented collation pattern of ID “1” and the front-oriented collation pattern of ID “2”.

In the above-described way, the human body detection unit 104 detects a specific object using the pattern according to the angle of the set line or graphic pattern.

In this embodiment, the collation pattern to be used is switched. However, the collation pattern to be used may be decided so as to change the order of using the collation patterns. For example, when the sensing line set angle α is 30°, it falls within the range of 0° (inclusive) to 45° (exclusive). Hence, the human body detection processing may be performed first using the front-oriented collation pattern of ID “2”. If no human body is detected, the detection processing may be performed next using the omnidirectional collation pattern of ID “3”. Finally, the human body detection processing may be performed using the laterally-oriented collation pattern of ID “1”.

The human body detection processing module may change the internal processing order of a collation pattern by inputting an angle parameter in one collation pattern, instead of switching the collation pattern to be used. That is, any internal processing configuration or processing order is usable as long as the human body detection processing method is switched in accordance with the sensing line set angle α.

As a technique of switching the human body detection processing method in accordance with the sensing line set angle α, the collation pattern may be changed in accordance with the passage determination direction of the sensing line as well as the sensing line set angle. For example, a left-side human body collation pattern and a right-side human body collation pattern are prepared in advance as collation patterns to be used in human body detection. In the example shown in FIG. 6, only processing of detecting a human body passing from left to right suffices. Hence, the human body detection processing is performed using only the right-side human body collation pattern.

The human body detection unit 104 thus detects a specific object using a plurality of types of patterns stored by the human body detection unit 104 in an order decided in accordance with the angle of the set line or graphic pattern.

The collation pattern decision method and human body detection processing by the human body detection unit 104 have been described above. In this way, a specific object can be detected from video data to display a video on the display screen in accordance with the tilt of the set line or graphic pattern.

Referring back to FIG. 1, the functions of the remaining processing units of the image processing apparatus 100 will be explained. The object association unit 106 associates the object detected by the object detection unit 102 with the human body detected by the human body detection unit 104. An example of association between a detected object and a detected human body will be described with reference to FIGS. 3A and 3B. FIG. 3A shows an example in which a circumscribed rectangle 302 of a detected human body is not included in a circumscribed rectangle 301 of a detected object. In this case, association is performed when the overlap ratio of the circumscribed rectangle 302 of the human body to the circumscribed rectangle 301 of the object exceeds a preset threshold. The overlap ratio is the ratio of the area of the portion where the circumscribed rectangle 301 of the object overlaps the circumscribed rectangle 302 of the human body to the area of the circumscribed rectangle 302 of the human body. On the other hand, FIG. 3B shows an example in which a plurality of human bodies are detected from a circumscribed rectangle 303 of a detected object. In this case, association is performed when the overlap ratio of each of a circumscribed rectangle 304 of a human body and a circumscribed rectangle 305 of another human body to the circumscribed rectangle 303 of the object exceeds the preset threshold.

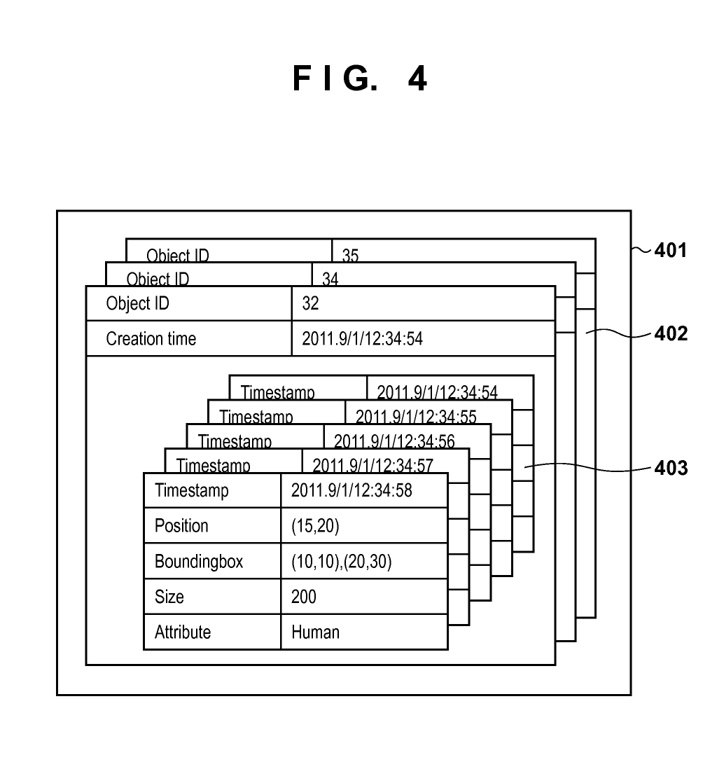

The locus management unit 107 manages object information obtained from the object detection unit 102 and the object tracking unit 103 as management information for each object. An example of management information managed by the locus management unit 107 will be described with reference to FIG. 4. In management information 401, object information 402 is managed for each object ID. In the object information 402 corresponding to one object ID, information 403 of each frame in which the object has been detected is managed. The information 403 includes a timestamp representing the date/time of creation of the information, the coordinate position (Position) of the detected object, information (Bounding box) that defines the circumscribed rectangle including the region of the detected object, the size of the object, and the attribute of the object. However, the pieces of information included in the information 403 are not limited to those, and any other information may be included if processing to be described below can be achieved. The management information 401 managed by the locus management unit 107 is used by the locus information determination unit 108.

The locus management unit 107 updates the attribute of the object in accordance with the association result of the object association unit 106. The attribute of a past object may also be updated in accordance with the association result. The attribute of a succeeding object may also be set in accordance with the association result. With this processing, the tracking result of objects having the same object ID can have the same attribute at any time.

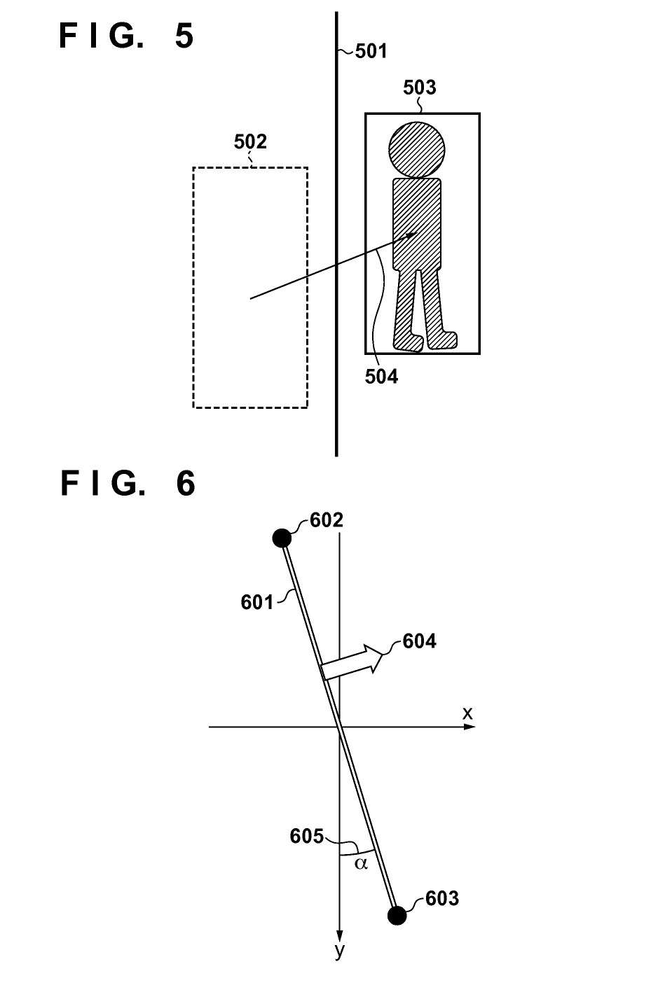

The locus information determination unit 108 has the function of a passing object sensing unit. The locus information determination unit 108 performs processing of determining the passage of an object across the sensing line for object sensing in accordance with the determination parameter obtained or set by the determination parameter setting unit 105 and the management information managed by the locus management unit 107. Processing performed by the locus information determination unit 108 when the determination parameter described with reference to FIG. 2 has been set will be described with reference to FIG. 5.

The locus information determination unit 108 determines whether a motion vector 504 from a circumscribed rectangle 502 of a human attribute object in a frame immediately before a frame of interest to a circumscribed rectangle 503 of a human attribute object in the frame of interest crosses a line segment 501 defined by the determination parameter. Determining whether the lines cross corresponds to determining whether the human attribute object has passed the line segment 501. The determination result of the locus information determination unit 108 can externally be output through the external output unit 109. If the external output unit 109 has the function of a display unit formed from a CRT, a liquid crystal panel, or the like, the determination result may be displayed using the external output unit 109 in place of the display device 110.

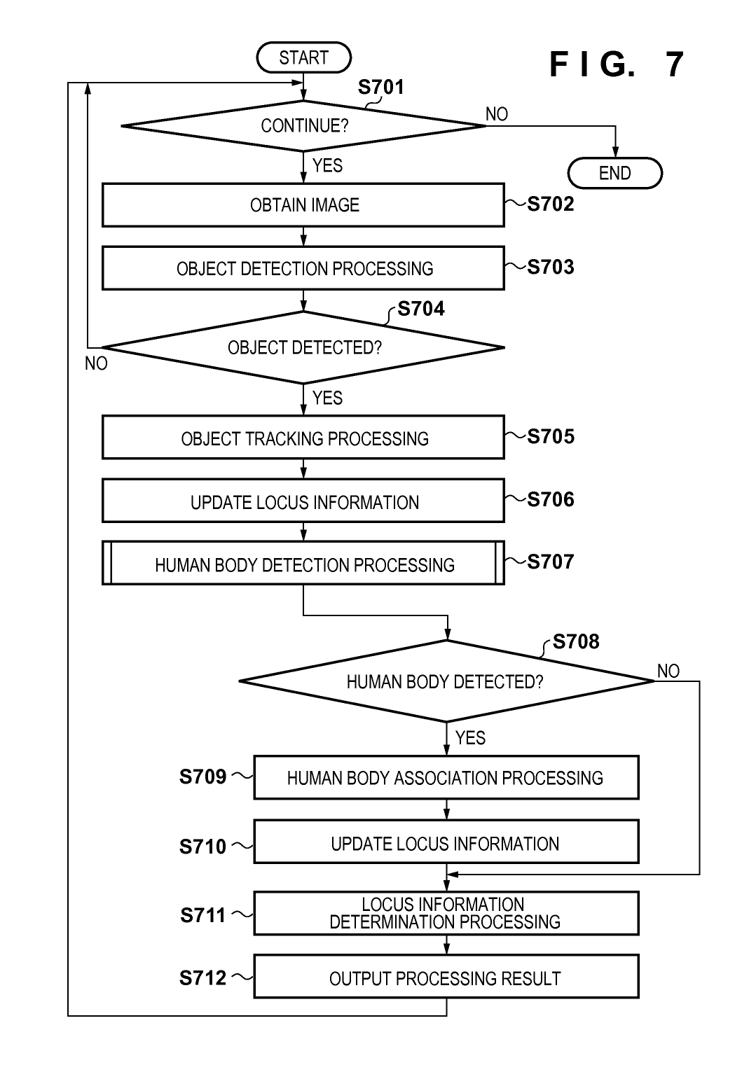

The procedure of processing executed by the image processing apparatus 100 according to the first embodiment will be described next with reference to the flowchart of FIG. 7. Note that the determination parameter as shown in FIG. 2 has already been registered in the image processing apparatus 100 at the time of starting the processing according to the flowchart.

In step S701, a control unit (not shown) provided in the image processing apparatus 100 determines whether to continue the processing. The control unit determines whether to continue the processing in accordance with, for example, whether an instruction to end the processing has been received from the user. Upon determining to continue the processing (YES in step S701), the process advances to step S702. Upon determining to end the processing (NO in step S701), the processing ends.

In step S702, the image obtaining unit 101 obtains an image input to the image processing apparatus 100. In step S703, the object detection unit 102 performs object detection processing for the obtained image. In step S704, the object detection unit 102 determines whether an object has been detected in step S703. Upon determining that an object has been detected (YES in step S704), the process advances to step S705. Upon determining that no object has been detected (NO in step S704), the process returns to step S701.

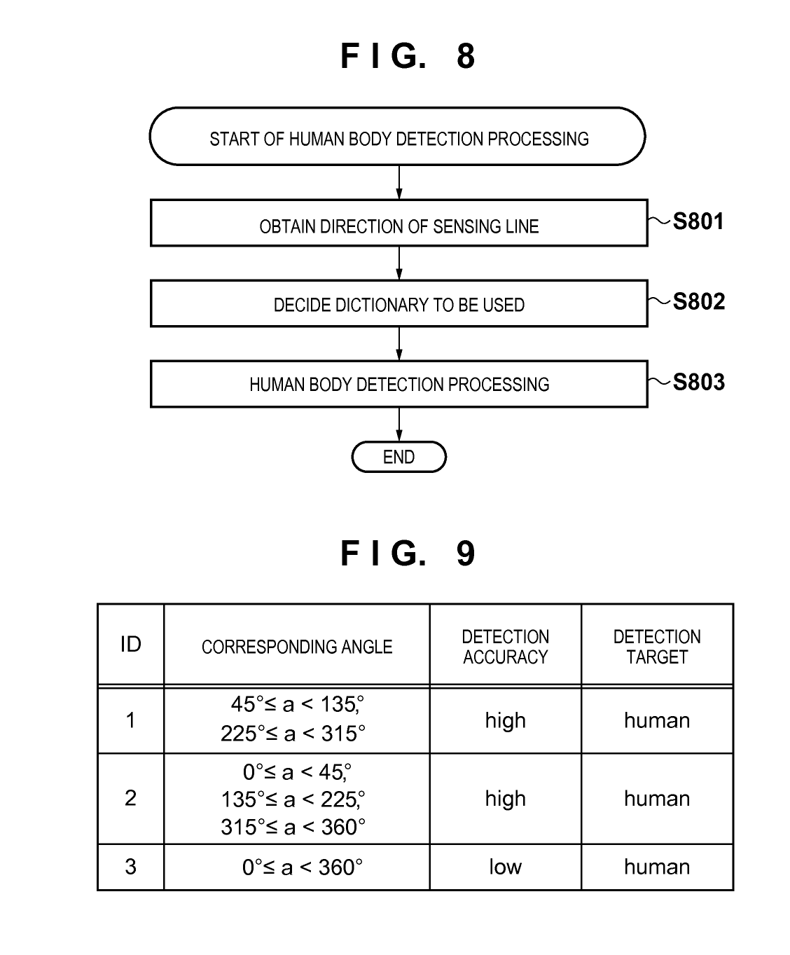

In step S705, the object tracking unit 103 performs object tracking processing. In step S706, the locus management unit 107 updates the locus information in accordance with the tracking processing result in step S705. In step S707, the human body detection unit 104 performs human body detection processing for the object detected by the object detection unit 102. Details of the human body detection processing will be described here with reference to the flowchart of FIG. 8.

In step S801, the human body detection unit 104 obtains the determination parameter (setting information such as the arrangement direction information and passage direction information of the sensing line for sensing) set by the determination parameter setting unit 105. In step S802, the human body detection unit 104 decides the collation pattern to be used in accordance with the determination parameter obtained in step S801. In step S803, the human body detection unit 104 performs human body detection processing using the collation pattern decided in step S802. After the human body detection processing has been performed in step S803, the process advances to step S708 of FIG. 7.

In step S708, the human body detection unit 104 determines, in accordance with the human body detection result processed in step S707, whether a human body has been detected. Upon determining that a human body has been detected (YES in step S708), the process advances to step S709. Upon determining that no human body has been detected (NO in step S708), the process advances to step S711.

In step S709, the object association unit 106 performs association processing of the object and the human body. In step S710, the locus management unit 107 updates the locus information based on the association processing result in step S709. In step S711, the locus information determination unit 108 performs locus information determination processing and determines whether the object has passed the sensing line. In step S712, the external output unit 109 externally outputs the determination result, and the process returns to step S701. Each process of the flowchart shown in FIG. 7 thus ends.

Above described is the processing of arranging a virtual graphic pattern or a straight line in the screen as the place to sense a passage in a video and switching the collation pattern dictionary to be used for passage sensing in accordance with the arrangement direction information and passage direction information of the straight line. However, the virtual graphic pattern that is the place to sense a passage is not limited to the straight line, and any other graphic pattern is usable as long as the passage direction is known. For example, a graphic pattern that two-dimensionally expresses a specific place in a three-dimensional space in a video or a virtual region set on the three-dimensional space is usable. Any other graphic pattern is usable if the passage direction in the graphic on the video is known. In this embodiment, a visually recognizable virtual graphic pattern is arranged and displayed on the screen as the place to sense a passage. However, the graphic pattern need not always be displayed if it is virtual.

As described above, according to this embodiment, it is possible to quickly and accurately sense that an object has passed through a specific place in a video using the video obtained from a monitoring camera or the like.

### Second Embodiment

In the first embodiment, the sensing line set on the screen has the form of a line segment having a start point and an end point, and only one sensing line is set. However, for example, a polygonal sensing line having a plurality of nodes may be set. Alternatively, a plurality of sensing lines may be set at different positions.

Collation pattern decision processing according to the second embodiment will be described with reference to a screen display example shown in FIG. 10. Note that object detection processing and object tracking processing have already been executed at the time of starting human body detection processing. The same reference numerals as in the image processing apparatus 100 shown in FIG. 1 denote the same constituent elements in this embodiment, and a description thereof will be omitted. Points different from the first embodiment will be explained below, and those not particularly mentioned below are assumed to be the same as in the first embodiment.

A sensing line 1002 shown in FIG. 10 includes a line segment 1007 that connects a start point 1003 and a node 1004, a line segment 1008 that connects the node 1004 and a node 1005, and a line segment 1009 that connects the node 1005 and an end point 1006. A sensing line 1010 different from the sensing line 1002 is set on the screen. An object detection unit 102 detects an object 1001 on the left side of the screen.

A human body detection unit 104 obtains the determination parameters (setting information) of the sensing lines 1002 and 1010 from a determination parameter setting unit 105, and decides the collation pattern to be used based on the set angle α (arrangement direction information) and the passage direction information of each line segment of the sensing lines included in the determination parameters. Human body detection processing according to this embodiment will be described below in detail.

The human body detection unit 104 obtains the sensing line (the sensing line 1002 in the example shown in FIG. 10) closest to the object 1001 from the plurality of set sensing lines. If the obtained sensing line is a polygonal line having a plurality of line segments, the set angle α of the line segment located closest to the object 1001 out of the line segments forming the sensing line is obtained and used as the determination criterion for collation pattern decision. As the closest line segment, a line segment whose middle point has the shortest distance to the object center is obtained. The point used to obtain the distance is not limited to the middle point of each line segment, and may include a predetermined point on a line segment such as the end node of a line segment or points at a predetermined interval.

Referring to FIG. 10, the sensing line segment having a middle point closest to the object 1001 is the line segment 1007. Hence, the human body detection unit 104 decides the collation pattern to be used in the human body detection processing by looking up the collation pattern table shown in FIG. 9 based on the set angle α of the line segment 1007.

Note that the collation pattern may be obtained not from the line segment closest to the object 1001 but from the set angles of one or a plurality of line segments located within a predetermined range from the object 1001. For example, if the sensing line segments located within a predetermined range from the object 1001 are the line segments 1007 and 1009 in FIG. 10, the collation pattern to be used is decided based on the set angles of the two line segments.

Alternatively, a plurality of collation patterns may be decided based on not only a sensing line segment located within a predetermined range but also a plurality of sensing line segments connected to both ends of the sensing line segment via nodes. In the example shown in FIG. 10, if the line segment within the predetermined range is the line segment 1007, a collation pattern is decided based on the line segment 1008 as well. That is, human body detection processing is performed using a collation pattern corresponding to the set angle of the line segment 1007 and a collation pattern corresponding to the set angle of the line segment 1008. The order to use the collation patterns is set to the ascending order of the distance between the line segment and the object 1001.

Note that instead of obtaining the closest sensing line as the determination criterion for collation pattern decision using the object 1001 as the reference, the movement of the object may be predicted, and the predicted position may be used as the reference. For example, instead of using the position of the object detected by the object detection unit 102 as the reference, an object tracking unit 103 performs processing of predicting the moving position of the object in the next frame based on the object movement history. Next, a virtual graphic pattern close to the object may be determined using the predicted object position as the reference, and collation processing may be decided in accordance with the setting information of the virtual graphic pattern. The predicted object position can be calculated from the motion vector of the object obtained from a frame before the processing target frame. Any other method is usable as long as it allows to predict the position.

The human body detection unit 104 thus selects one of the plurality of set lines based on the predicted moving position of the object. Then, in accordance with the angle of the selected line, a specific object is detected from video data to display a video on the display screen.

In this embodiment, a sensing line to be set is a straight line. However, it may be a curved line. In this case, every curved line can be approximated to a plurality of straight lines. For this reason, approximation to straight lines is performed first. After that, the same processing as described above is performed, thereby deciding the collation pattern to be used.

As described above, according to this embodiment, it is possible to quickly and accurately sense that an object has passed a plurality of sensing lines or a polygonal sensing line set in an image using a video obtained from a monitoring camera or the like.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-085892 filed on Apr. 4, 2012, which is hereby incorporated by reference herein in its entirety.

What is claimed is:

1. A video processing apparatus comprising:
a setting unit that sets one of a line and a graphic pattern on a display screen of a video; and
a detection unit that detects, in accordance with an angle of one of the line and the graphic pattern set by said setting unit, a specific object from video data to display the video on the display screen.

2. The apparatus according to claim 1, further comprising a storage unit that stores a plurality of types of patterns to be used by said detection unit to detect the specific object from the video data,
wherein said detection unit detects the specific object using a pattern according to the angle of one of the line and the graphic pattern set by said setting unit out of the plurality of types of patterns stored in said storage unit.

3. The apparatus according to claim 1, further comprising a storage unit that stores a plurality of types of patterns to be used by said detection unit to detect the specific object from the display screen,
wherein said detection unit detects the specific object using the plurality of types of patterns stored in said storage unit in an order decided in accordance with the angle of one of the line and the graphic pattern set by said setting unit.

4. The apparatus according to claim 1, further comprising a prediction unit that predicts a position on the display screen to which the object on the display screen moves,
wherein said setting unit sets a plurality of lines on the display screen, and
said detection unit selects one line out of the plurality of lines set by said setting unit based on the position on the display screen predicted by said prediction unit and detects the specific object from the video data to display the video on the display screen in accordance with an angle of the selected line.

5. The apparatus according to claim 1, further comprising a sensing unit that senses that a moving object has passed through a region on the display screen corresponding to one of the line and the graphic pattern set by said setting unit.

6. The apparatus according to claim 1, further comprising a sensing unit that senses that a moving object has passed through a region on the display screen corresponding to one of the line and the graphic pattern set by said setting unit,
wherein said setting unit sets a passage direction in which the object passes one of the set line and the set graphic pattern,
said sensing unit senses that the moving object has passed through the region on the display screen corresponding to one of the line and the graphic pattern set by said setting unit in the set passage direction, and
said detection unit detects the specific object from the video data to display the video on the display screen in accordance with the passage direction set by said setting unit.

7. A video processing method comprising:
a setting step of setting one of a line and a graphic pattern on a display screen of a video; and
a detection step of detecting, in accordance with an angle of one of the line and the graphic pattern set in the setting step, a specific object from video data to display the video on the display screen.

8. The method according to claim 7, further comprising a storage step of storing, in a storage unit, a plurality of types of patterns to be used in the detection step to detect the specific object from the video data,
wherein in the detection step, the specific object is detected using a pattern according to the angle of one of the line and the graphic pattern set in the setting step out of the plurality of types of patterns stored in the storage unit.

9. The method according to claim 7, further comprising a storage step of storing, in a storage unit, a plurality of types of patterns to be used in the detection step to detect the specific object from the display screen,
wherein in the detection step, the specific object is detected using the plurality of types of patterns stored in the storage unit in an order decided in accordance with the angle of one of the line and the graphic pattern set in the setting step.

10. The method according to claim 7, further comprising a sensing step of sensing that a moving object has passed through a region on the display screen corresponding to one of the line and the graphic pattern set in the setting step,
wherein in the setting step, a passage direction in which the object passes one of the set line and the set graphic pattern is set,
in the sensing step, it is sensed that the moving object has passed through the region on the display screen corresponding to one of the line and the graphic pattern set in the setting step in the set passage direction, and
in the detection step, the specific object is detected from the video data to display the video on the display screen in accordance with the set passage direction.

11. A non-transitory computer-readable storage medium storing a program for causing a computer to execute video processing, the program comprising:
a setting step of setting one of a line and a graphic pattern on a display screen of a video; and
a detection step of detecting, in accordance with an angle of one of the line and the graphic pattern set in the setting step, a specific object from video data to display the video on the display screen.

12. The medium according to claim 11, further comprising a storage step of storing, in a storage unit, a plurality of types of patterns to be used in the detection step to detect the specific object from the video data,
wherein in the detection step, the specific object is detected using a pattern according to the angle of one of the line and the graphic pattern set in the setting step out of the plurality of types of patterns stored in the storage unit.

13. The medium according to claim 11, further comprising a storage step of storing, in a storage unit, a plurality of types of patterns to be used in the detection step to detect the specific object from the display screen,
wherein in the detection step, the specific object is detected using the plurality of types of patterns stored in the storage unit in an order decided in accordance with the angle of one of the line and the graphic pattern set in the setting step.

14. The medium according to claim 11, further comprising a sensing step of sensing that a moving object has passed through a region on the display screen corresponding to one of the line and the graphic pattern set in the setting step,
wherein in the setting step, a passage direction in which the object passes one of the set line and the set graphic pattern is set,
in the sensing step, it is sensed that the moving object has passed through the region on the display screen corresponding to one of the line and the graphic pattern set in the setting step in the set passage direction, and
in the detection step, the specific object is detected from the video data to display the video on the display screen in accordance with the set passage direction.
